(19) United States
(12) Patent Application Publication
(10) Pub. No.: US 2013/0238448 A1
(43) Pub. Date: Sep. 12, 2013

(54) Guaranteeing Delivery of Ad Impressions

(71) Applicants: Eduardo Villasenor, Seattle, WA (US); Bashar Kachachi, Kirkland, WA (US); Rohan Bhattacharjee, Redmond, WA (US); Izzet Can Envarli, Kirkland, WA (US); Paul Gorman, Woodinville, WA (US); Corneliu Manescu, Redmond, WA (US); Manan Sanghi, Bellevue, WA (US); Karlton Sequeira, Seattle, WA (US); Ramana Yerneni, Bothell, WA (US)

(72) Inventors: Eduardo Villasenor, Seattle, WA (US); Bashar Kachachi, Kirkland, WA (US); Rohan Bhattacharjee, Redmond, WA (US); Izzet Can Envarli, Kirkland, WA (US); Paul Gorman, Woodinville, WA (US); Corneliu Manescu, Redmond, WA (US); Manan Sanghi, Bellevue, WA (US); Karlton Sequeira, Seattle, WA (US); Ramana Yerneni, Bothell, WA (US)

(73) Assignee: Microsoft Corporation, Redmond, WA (US)

(21) Appl. No.: 13/415,911

(22) Filed: Mar. 9, 2012

(51) Int. Cl. G06Q 30/02

(52) U.S. Cl. 705/14.71; 705/14.69

(57) ABSTRACT

Various embodiments pertain to techniques for forecasting and providing guaranteed delivery of ad impression opportunities using real-time bidded platform inventories. In various embodiments, bid landscape data, such as information regarding a number of impression requests by a particular supply unit, a time of the impression requests, and an amount of a winning bid for the impression requests, is recorded for use in forecasting an available impression volume as a function of cost. The forecasted available impression volume represents a number of ad impression requests likely to be obtained through real-time bidding channels. In various embodiments, an advertiser can place an order for a number of ad impressions at a particular price, and the ad impressions ordered can be specifically allocated for that advertiser. The number of ad impressions ordered by an advertiser that are guaranteed vary depending on the price and the available volume forecasted at that price.

### BACKGROUND

Online publishers typically provide or allocate portions of their online media surfaces (including web pages and applications), for advertising purposes as a means of media monetization. When this media is used, loaded or viewed, there is an opportunity to populate these areas with an advertisement, sometimes referred to as an impression opportunity. Some of the impression opportunities are available for advertising products, services or businesses not directly provided by or related to the online publishers. These impression opportunities can be made available to advertisers and/or advertising agencies for a price either directly, or through various platforms operating as middlemen such as one or more advertising networks (sometimes referred to as “ad networks”), one or more demand-side platforms (DSPs), or one or more real-time bidding (“RTB”) platforms such as advertising exchanges (sometimes referred to as “ad exchanges”). In some instances, ad exchanges provide a platform for the buying and selling of advertising impressions by consolidating and managing impression opportunities across a number of publishers or resellers and making them available for a number of advertisers or advertising agencies or other resellers, usually through a RTB interface. Advertisers interested in impression opportunities may be represented by one or more advertising agencies that procure or buy impression opportunities based on the advertising campaign using the RTB platform.

Impression opportunities can be guaranteed in some instances and non-guaranteed in other instances. For example, an advertiser or advertising agency can purchase a guaranteed number of impression opportunities from an ad network that has been allotted a certain number of impression opportunities by online publishers. Alternately or additionally, an advertiser can purchase a non-guaranteed number of impression opportunities from one or more ad exchanges via a demand-side platform (“DSP”). Impression opportunities from DSPs may be less costly per impression because they are not guaranteed. Since DSPs obtain at least a portion of their impression opportunities from RTB platforms rather than an allocation, it can be difficult to guarantee delivery of a number of ad impression opportunities to an advertiser.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for forecasting and providing guaranteed delivery of ad impression opportunities using RTB-sourced inventories. In various embodiments, a system records bid landscape data for use in forecasting an available impression volume as a function of cost. Bid landscape data can include information regarding a number of impression requests by a particular supply unit, a time of the impression requests, and an amount of a winning bid for the impression requests. Additional data available from the requests can be used to forecast the volume of impressions with a specific data configuration as a function of cost. The forecasted available impression volume can represent a number of ad impression requests likely to be obtained through RTB platforms. In various embodiments, an advertiser can place an order for a number of ad impressions at a particular price and with a particular composition of data configuration, and the ad impressions ordered can be specifically allocated for that advertiser. The number of ad impressions ordered by an advertiser that are guaranteed can vary depending on the price indicated by the advertiser and the available volume forecasted at that price.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIG. 2 illustrates an example advertisement platform in accordance with one or more embodiments;

FIG. 3 is a block diagram of an example process in accordance with one or more embodiments;

FIG. 4 is a block diagram of an example process in accordance with one or more embodiments;

FIG. 5 is a block diagram of an example process in accordance with one or more embodiments; and

FIG. 6 illustrates an example device that can be used to implement one or more embodiments.

### DETAILED DESCRIPTION

### Overview

Various embodiments pertain to techniques for forecasting and providing guaranteed delivery of ad impression opportunities using real-time bidded inventories. In various embodiments, a system records bid landscape data for use in forecasting an available impression volume as a function of cost. Bid landscape data can include information regarding a number of impression requests by a particular supply unit, a time of the impression requests, an amount of a winning bid for the impression requests, an amount of a clearing price for the impression requests, and other information from real-time bidding or auctioning of ad impressions. The forecasted available impression volume can represent a number of ad impression requests likely to be obtained through RTB platforms.

In various embodiments, an advertiser can place an order for a number of guaranteed ad impressions at a particular price. For example, the advertiser can place an order for ten thousand ad impressions at a price of two dollars per impression. The ad impressions ordered can be specifically allocated within the available impressions for that advertiser, and the available impression volume is adjusted accordingly. The number of ad impressions ordered by an advertiser that are guaranteed can vary depending on the price indicated by the advertiser and the available volume forecasted at that price. For example, if the forecasted available impression volume at the two dollar price point is greater than ten thousand ad impressions, the advertiser's order can be guaranteed. However, if the forecasted available impression volume at the two dollar price point is less than ten thousand ad impressions, a portion of the advertiser's order may be guaranteed while another portion of the advertiser's order may not be guaranteed. In some embodiments, an alternative price can be suggested to an advertiser such that the price enables a guarantee to be made for the requested number of ad impressions.

In the discussion that follows, a section entitled “Example Operating Environment” describes an operating environment in accordance with one or more embodiments. Next, a section entitled “Example Embodiments” describes various techniques for forecasting an available volume of ad impressions for use in guaranteeing delivery of ad impressions. Finally, a section entitled “Example Device” describes a device that can be used to implement one or more embodiments.

Consider now, an example operating environment in accordance with one or more embodiments.

Example Operating Environment

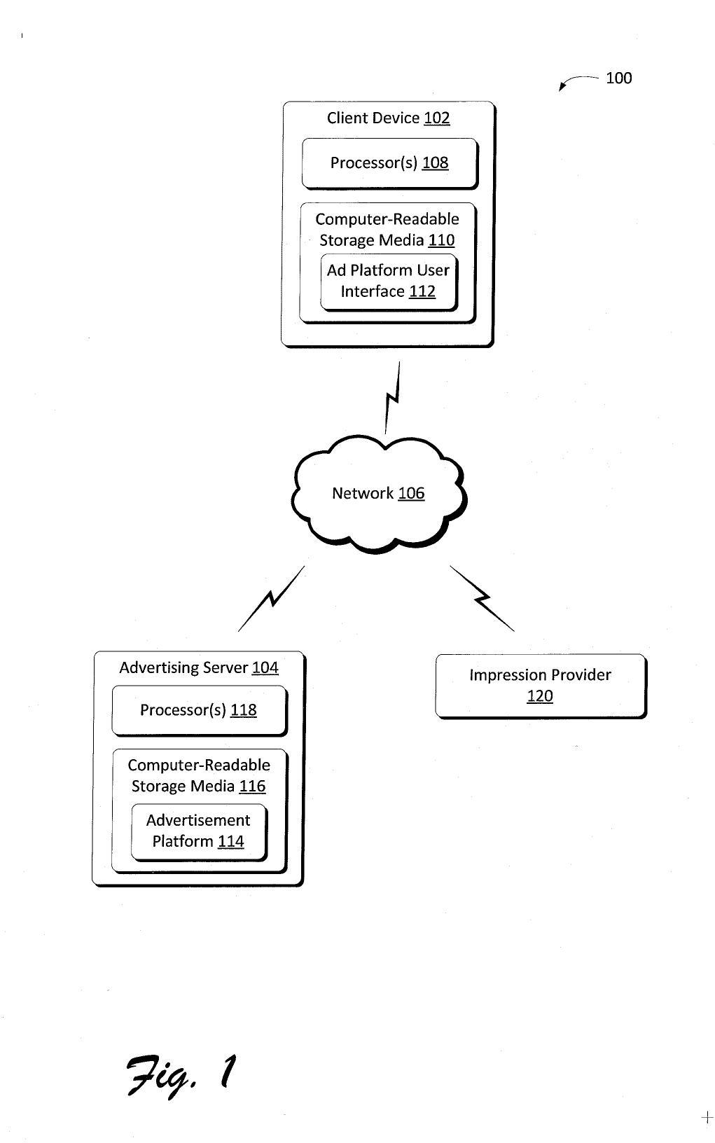

FIG. 1 is an illustration of an example environment 100 in accordance with one or more embodiments. Environment 100 includes a client device 102 communicatively coupled to an advertising server 104 through a network 106.

Client device 102 can include one or more processors 108 and computer-readable storage media 110. Client device 102 can be embodied as any suitable computing device such as, by way of example and not limitation, a desktop computer, a portable computer, a netbook, a handheld computer such as a personal digital assistant (PDA), a cell phone, and the like.

Computer-readable storage media 110 includes one or more software applications, which can include a software executable module in the form of an ad platform user interface 112. Ad platform user interface 112 can receive content from and send content to other servers, such as advertising server 104, via network 106, such as the Internet. In various embodiments, ad platform user interface 112 is configured to ascertain a user input regarding a desired number of ad impressions and send an order for a number of ad impressions to an advertisement platform 114. Responsive to the order, advertisement platform 114 can attempt to obtain ad impressions on behalf of the client device 102.

Ad impressions may be impression opportunities that can include any form or type of space or region on a web page or program or application. The impression opportunity may overlap with, reside within, or be part of content on the web page or program or application (e.g., locations for banners, ad blocks, sponsored listings, margin ads, flash displays, and the like), although in some embodiments, the impression opportunity does not directly reside on a web page or program or application. For example, in some embodiments, an impression opportunity in the form of a pop up window may be generated in response to a user action, such as clicking a button on an input device or causing a mouse indicator to hover over a particular portion of the web page. In some embodiments, the impression opportunity is temporal, e.g., associated with a time slot, such as before a requested video clip or at a particular time of day.

In various embodiments, impression opportunities or ad impressions from various sources, such as online publishers or ad impression resellers, can be consolidated and sold to advertisers via the advertisement platform 114. Advertisement platform 114 resides on computer-readable storage media 116 of advertising server 104. In addition to computer-readable storage media 116, advertising server 104 also includes one or more processors 118 configured to execute the software modules, e.g., advertisement platform 114, residing on computer-readable storage media 116. In various embodiments, advertising platform 114 is configured to receive and process orders for ad impressions from client device 102. Advertising platform 114 is also configured to obtain ad impressions to fulfill the order from an inventory of non-guaranteed ad impressions. The ad impressions can be obtained from one or more impressions providers, such as impression provider 120, each of which can represent ad impressions from one or more online publishers.

In various embodiments, impression provider 120 is a RTB platform (e.g., a real-time bidded inventory of ad impressions). In various embodiments, RTB platforms can serve to broker transactions between advertisement platform 114 and the online publishers. For example, advertisement platform 114 may make a bid on a number of ad impressions and the RTB platform can institute an auction for the ad impressions. If advertisement platform 114 wins the auction, it can then fulfill the order received from client device 102 with the ad impressions won.

In various embodiments, regardless of whether advertisement platform 114 wins an auction from impression provider 120, advertisement platform 114 records information about the auction, or bid landscape data. Bid landscape data can include information regarding a number of impression requests by a particular supply unit, a time of the impression requests, an amount of a winning bid for the impression requests, an amount of a winning clearing price for the impression requests, and/or other information from real-time bidding or auctioning of ad impressions. Utilizing this data, advertisement platform 114 is configured to forecast an available impression volume representing a number of ad impression requests likely to be obtained from various impression providers as a function of cost. In various embodiments, advertisement platform 114 can guarantee a number of impressions less than or equal to the available impression volume in response to an order received from client device 102, as described in more detail below.

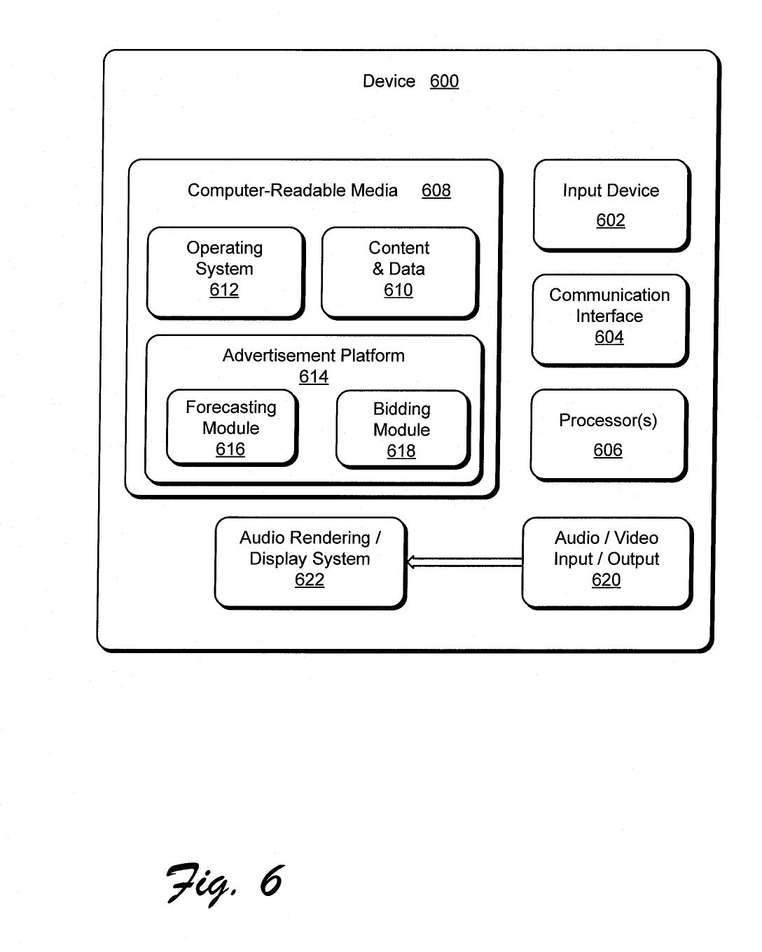

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific, example of a computing device is shown and described below in FIG. 6.

Generally, any of the functions described herein can be implemented using software, firmware, hardware (e.g., fixed logic circuitry) or a combination of these implementations. The terms “module,” “functionality,” and “logic” as used herein generally represent software, firmware, hardware, or a combination thereof. In the case of a software implementation, the module, functionality, or logic represent program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Environment 100 is referenced by the following description of various embodiments in which guaranteed delivery of ad impression opportunities is provided and fulfilled using RTB platform inventories.

### Example Embodiments

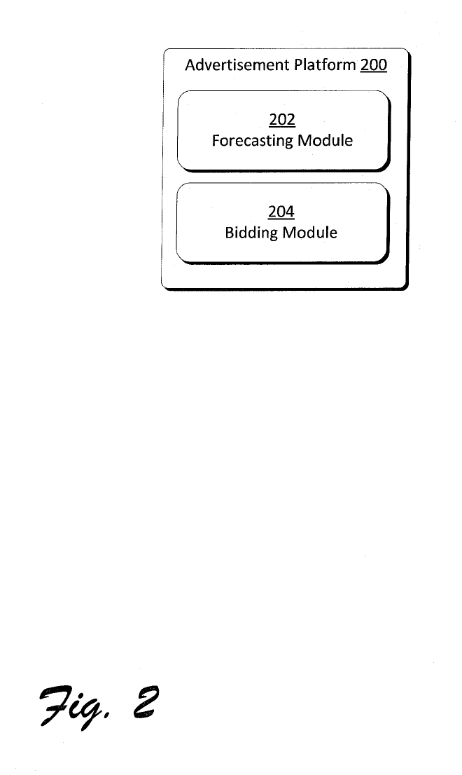

FIG. 2 illustrates an advertisement platform 200 in accordance with one or more embodiments. Advertisement platform 200 can be, for example, advertisement platform 114 as illustrated in FIG. 1. As shown in FIG. 2, advertisement platform 200 includes a forecasting module 202 and a bidding module 204. Other components may be included, depending on the particular embodiment.

In one or more embodiments, forecasting module 202 is configured to record information about auctions, or bid landscape data, and determine an available impression volume. Bid landscape data can include information regarding a number of impression requests by a particular supply unit, a time of the impression requests, an amount of a winning bid for the impression requests, an amount of a winning clearing price for the impression requests, and other information from real-time bidding or auctioning of ad impressions. The forecasted available impression volume represents a number of ad impression requests likely to be obtained from various impression providers as a function of cost. In various embodiments, advertisement platform 200 can guarantee a number of impressions less than or equal to the available impression volume in response to an order received from client device 102.

In one or more embodiments, bidding module 204 is configured to receive ad impression opportunities, such as from impression providers, identify ad impression opportunities on which to bid, and transmit bids for those ad impression opportunities. In other words, bidding module 204 is configured to obtain ad impressions from impression providers for delivery to advertisers according to received orders. Working together, forecasting module 202 and bidding module 204 enable advertisement platform 200 forecast an amount of ad impressions that can be guaranteed according to various constraints and obtain ad impressions to fulfill guaranteed orders from an inventory of non-guaranteed ad impressions.

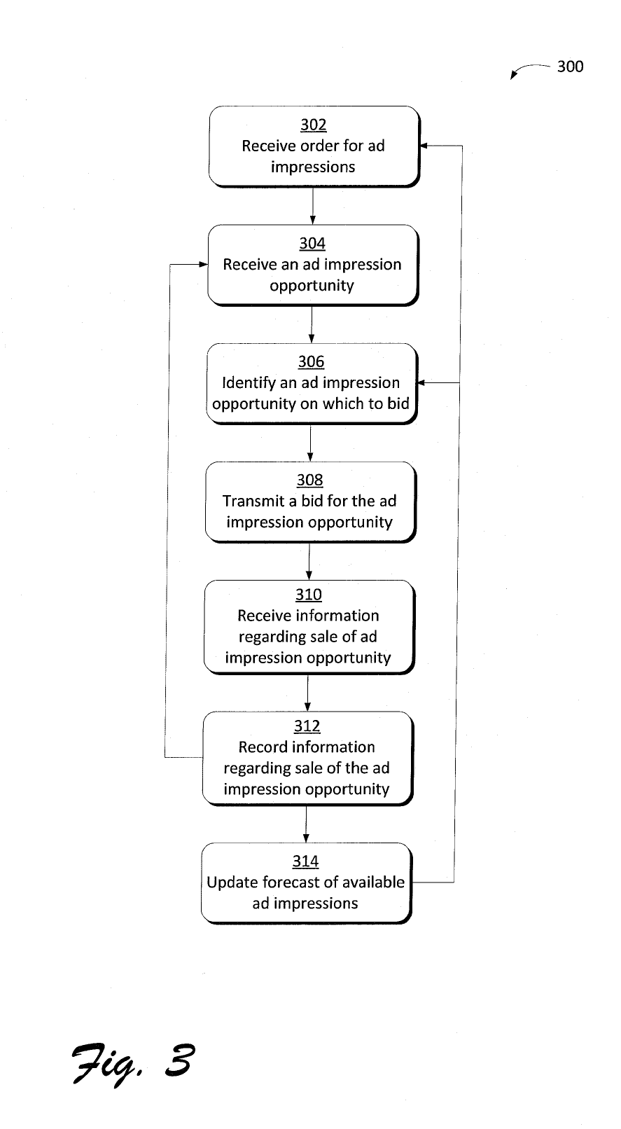

FIG. 3 is a block diagram of an example process 300 for determining an available ad impression volume in accordance with one or more embodiments. The process can be implemented in connection with any suitable hardware, software, firmware, or combination thereof. In at least some embodiments, the process can be implemented in software, such as by advertisement platform 114 or advertisement platform 200.

Block 302 receives an order for ad impressions. This can be performed in any suitable way. For example, advertisement platform 114 can receive an order for ad impressions from client device 102 via network 106. In various embodiments, more than one order for ad impressions is received from one or more client devices.

Next, block 304 receives an ad impression opportunity from anon-guaranteed source of ad impressions. This can be performed in any suitable way. For example, advertisement platform 114 can receive one or more ad impression opportunities from at least one impression providers, such as impression provider 120. In various embodiments, advertisement platform 114 receives ad impression opportunities from various real-time bidding platforms, in some embodiments, one or more ad networks.

Block 306 identifies an ad impression opportunity on which to bid. This can be performed in any suitable way. For example, advertisement platform 114 can determine that at least one of the ad impression opportunities received by block 304 includes inventory that can be used to fill an order for ad impressions received by block 302. Some ad impression opportunities may not be suitable for bidding, since the ad impression opportunities may be related to content or audiences that are not in line with the advertiser's campaign. For example, advertisement platform 114 may receive an order for ad impressions from an advertiser running a car advertisement campaign, so ad impression opportunities on websites directed to pre-teen girls may not be desired by the advertiser for that particular campaign. However, when advertisement platform 114 receives an ad impression opportunity for space on a sports website from impression provider 120, block 306 may identify it as an ad impression opportunity on which to bid.

Block 308 transmits a bid for the ad impression opportunity identified by block 306. This can be performed in any suitable way. For example, advertisement platform 114 can transmit a bid, such as $1 for an impression, to impression provider 120 through network 106. The amount of the bid transmitted can be determined according to a variety of factors, including but not limited to, the price for which the guaranteed impressions have been sold to the advertiser, whether the advertiser is ahead, on track or behind their impression delivery goal schedule, what the competing internal and external demand is bidding, a cap identified by the advertiser and included as part of the order for ad impressions received by block 302, historical data gathered by advertising platform 114, or the like.

Next, block 310 receives information regarding the sale of the ad impression opportunity. For example, block 310 can receive information that the bid transmitted by block 308 is a winning bid, that there has been a higher bid than the one transmitted by block 308, that the auction for the ad impression opportunity was won or lost, or information regarding the winning bid amount. This can be performed in any suitable way. For example, advertisement platform 114 can receive information regarding the outcome of the ad impression from impression provider 120 through network 106. The information received by block 310 is information that a notification of a win on a bid was not received. For example, if a notification that an auction was won is not received within a predetermined amount of time responsive to block 308 transmitting a bid, advertisement platform can receive information indicating that no information was received. In some embodiments, the received information can be generated by bidding module 204 and received by forecasting module 202.

Block 312 records the information regarding the sale of the ad impression opportunity that was received by block 210. This can be performed in any suitable way. For example, advertisement platform 114 can cause the information received from impression provider 120 to be stored on computer-readable media of advertising server 104. The loop from block 304 through 312 is repeated for each ad impression opportunity received. In some embodiments, information regarding an ad impression opportunity is recorded regardless of whether block 306 identifies it as an opportunity on which to bid. In other embodiments, information recorded can be limited to information regarding ad impression opportunities for which block 308 transmits a bid.

After information regarding the outcome of the ad impression opportunity is recorded by block 312, block 314 updates a forecast of available ad impressions. This can be performed in any suitable way. For example, in embodiments in which advertisement platform 114 is advertisement platform 200, forecasting module 202 can utilize the recorded information to determine an available ad impression volume such that orders received by block 302 at a given price can be guaranteed to the advertiser despite the uncertain nature of obtaining ad impressions through bidding. Bidding module 204 can utilize the updated forecast of available ad impressions to identify an ad impression opportunity on which to bid at block 306.

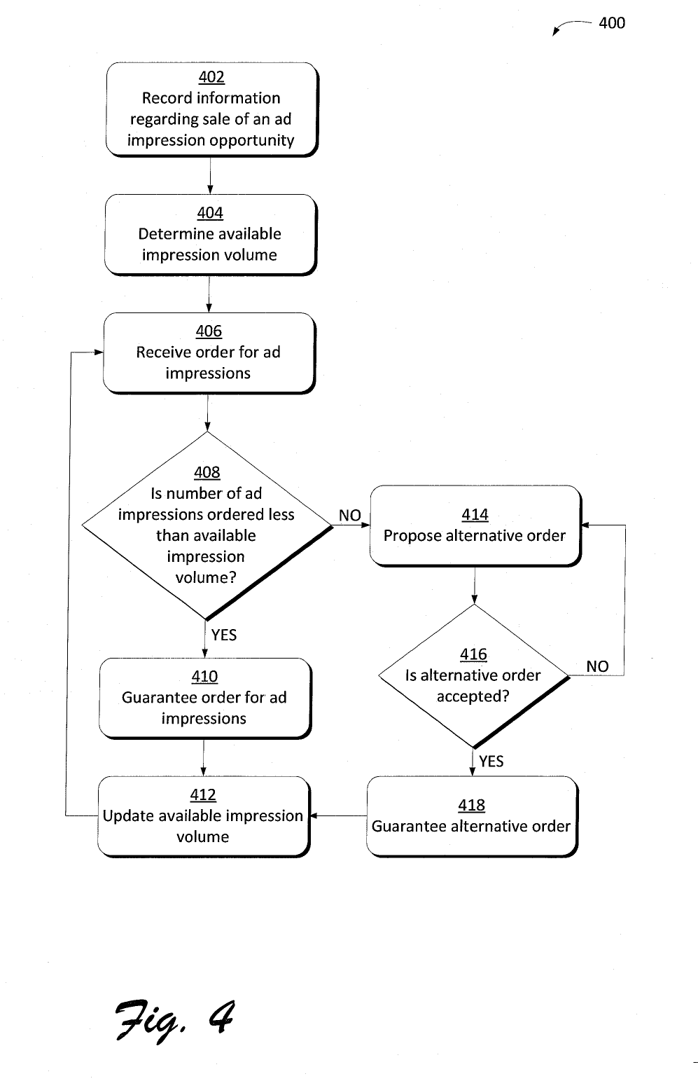

FIG. 4 depicts an example process 400 for utilizing information regarding the outcome of an ad impression opportunity to guarantee an order for ad impressions in accordance with one or more embodiments. The process can be implemented in connection with any suitable hardware, software, firmware, or combination thereof. In at least some embodiments, the process can be implemented in software, such as by advertisement platform 114 or advertisement platform 200.

Block 402 records information regarding a sale of an ad impression opportunity. This can be performed in any suitable way. For example, forecasting module 202 can record information regarding an outcome of an ad impression opportunity for which bidding module 204 submitted a bid.

Next, block 404 determines an available impression volume. This can be performed in any suitable way. For example, information recorded by block 402 can be input by forecasting module 202 into an algorithm to predict a price that will result in winning a given number of ad impressions. The information obtained and recorded by block 402 can be used to generate a graph depicting volume of ad impressions versus price. In some embodiments, the price can vary depending on a time (e.g., a time of day, a day of the week, or a time of month) or on some other factor, such as a target audience or properties of the ad impression. In various embodiments, the available impression volume can include inventory obtained from RTB platforms, although in some embodiments, the available impression volume can include inventory obtained from ad networks or other guaranteed ad impression supplies, in addition to inventory obtained from non-guaranteed sources of ad impressions, such as ad exchanges or other real-time bidded supplies.

Block 406 receives an order for ad impressions. This can be performed in any suitable way, examples of which are provided above and below. Next, block 408 determines if the number of ad impressions ordered is less than the available impression volume. This can be performed in any suitable way. For example, advertisement platform 200 can compare the number of ad impressions included in the order received by block 406 with the available impression volume determine by block 404. If the number of ordered ad impressions is less than the available impression volume, block 410 guarantees the order for ad impressions received by block 406, and block 412 updates the available impression volume accordingly. In some embodiments, if the number of ordered ad impressions is equal to the available impression volume, block 410 guarantees the order for ad impressions.

If, however, the number of ad impressions is greater than the number of available ad impressions, block 414 proposes an alternative order. This can be performed in any suitable way. For example, advertisement platform 200 can transmit a message to client device 102 through network 106 to be displayed to a user via ad platform user interface 112. The message can propose an alternative price, an alternative number of impressions, or some combination thereof. In various embodiments, the alternative order includes an alternative price that is higher than a price in the received order or an alternative number of impressions that is lower than the number of impressions in the received order. For example, if a request for 5,000 ad impressions at a CPM of $1 is not within the available impression volume, advertisement platform 114 may propose an order of 5,000 ad impressions at a CPM of $3, or an order of 2,000 ad impressions at a CPM of $1. In some embodiments, various alternative orders may be proposed.

Block 416 determines whether the alternative order is accepted. This can be performed in any suitable way. For example, advertisement platform 200 can receive an acceptance from client device 102 of the alternative order proposed by block 414, or a rejection of the alternative order.

If the alternative order is not accepted, the process can return to block 414 and propose another alternative order. Additional alternative orders can be proposed until an alternative order is determined to have been accepted by block 416, or a particular number of alternative orders was proposed. For example, upon the rejection of the second alternative order, the process may end and an advertiser can transmit a new order for ad impressions to be received by block 406.

When an alternative order is accepted, block 418 guarantees the alternative order, and block 412 updates the available impression volume. Block 412 can update the available impression volume in any suitable way. For example, the number of ad impressions guaranteed by blocks 410 or 418 can be deducted from the number of available impressions to result in an updated available impression volume. Once the available impression volume is updated, block 406 can receive the next order for ad impressions and compare the number of newly ordered ad impressions to the updated available impression volume.

While FIG. 4 describes a method in which orders for a number of impressions exceeding the available impression volume are not guaranteed, in some embodiments, orders for a number of impressions greater than the available impression volume can be guaranteed. For example, if an order is of high value, it may be booked guaranteed and prioritized above other orders with lower values.

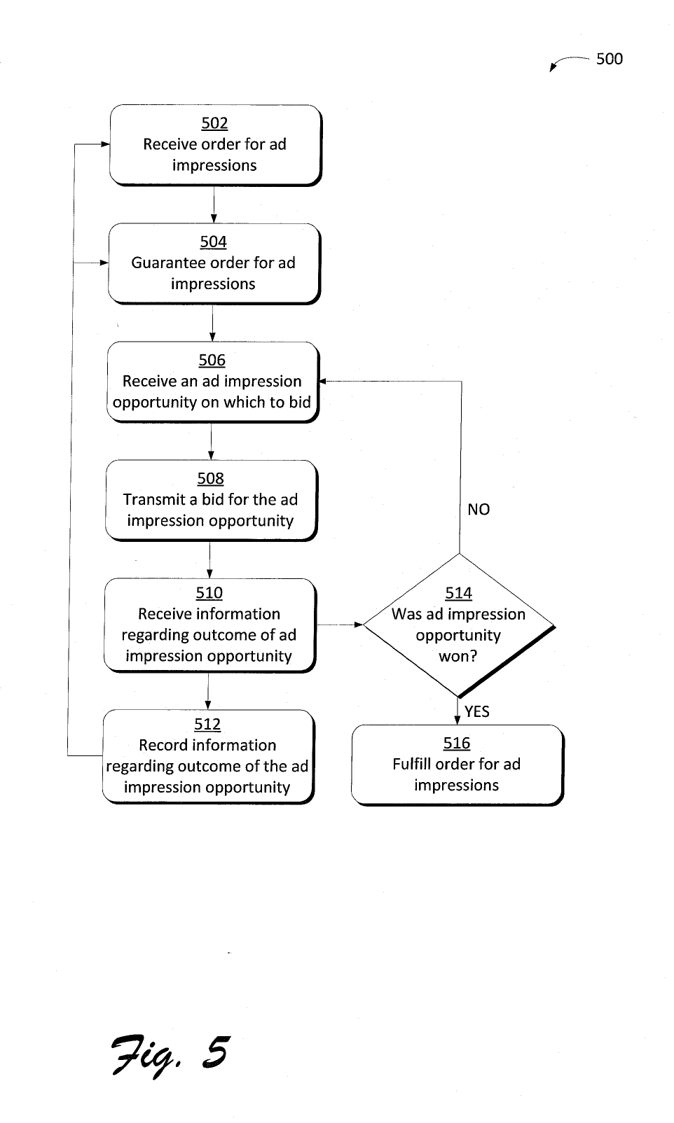

FIG. 5 is a block diagram of an example process 500 of fulfilling guaranteed ad impression orders in accordance with one or more embodiments. The process can be implemented in connection with any suitable hardware, software, firmware, or combination thereof. In at least some embodiments, the process can be implemented in software, such as advertisement platform 114 or advertisement platform 200.

Block 502 receives an order for ad impressions. This can be performed in any suitable way, examples of which are provided above and below. Next, block 504 guarantees the order for ad impressions. This can be performed in any suitable way, examples of which are provided above and below.

Block 506 receives an ad impression opportunity on which to bid. This can be performed in any suitable way, examples of which are provided above and below. Block 508 transmits a bid for the ad impression opportunity. This can be performed in any suitable way. For example, bidding module 204 can transmit a bid to an impression provider 120.

Next, block 510 receives information regarding the outcome of the ad impression opportunity. This can be performed in any suitable way, examples of which are provided above and below. Block 512 records the information regarding the outcome of the ad impression opportunity. This can be performed in any suitable way, examples of which are provided above and below. The recorded information can be used by blocks 502 and 504, for example, to determine pricing and availability.

Block 514 determines, based on the information received by block 510, whether the ad impression opportunity was won. This can be performed in any suitable way, examples of which are provided above and below. If the ad impression opportunity was won, block 516 fulfills the order for ad impressions received by block 502. If, however, the ad impression opportunity was not won, the process returns to block 506 to receive additional ad impression opportunities on which to bid.

The processes described above can enable an advertiser to purchase guaranteed ad impressions from an advertisement platform when the availability of ad impressions is not guaranteed to the platform. Traditionally, advertisement platforms could guarantee delivery of ad impressions when they were themselves guaranteed an inventory of impressions. For example, an advertisement platform could be allocated X number of ad impressions at price Y from certain publishers. With the knowledge that they could guarantee X ad impressions to advertisers, the advertisement platform could sell the ad impressions as guaranteed for a premium price. If, however, the advertisement platform did not have a guaranteed inventory from a particular publisher, ad impressions could be obtained through RTB platforms. Because advertisement platforms were uncertain as to whether they would be able to obtain the inventory ordered by an advertiser, the ad impressions were sold at a lower price and were not guaranteed.

Various embodiments described herein enable an advertisement platform to sell guaranteed ad impressions at a premium price to advertisers, even when the advertisement platform does not have a guaranteed inventory of ad impressions from which to fulfill the advertiser's order. In particular, the forecasting techniques described herein enable the advertising platform to monitor the outcome of various auctions or opportunities to obtain ad impressions and track the price to obtain the impressions. Based on that information, the advertisement platform may predict an available ad impression volume according to cost, time, or other constraints. When the advertisement platform receives an order for ad impressions, it can determine whether the order is likely to be fulfilled based on historical data, and if it is likely within a pre-determined risk threshold, the advertisement platform can guarantee the delivery of the order. The pre-determined risk threshold can vary depending on the particular embodiment according to the amount of risk the advertisement platform is willing to assume. In some embodiments, this threshold can be accounted for in a forecasting algorithm utilized to project an available volume of ad impressions.

Having described various embodiments of techniques to project an available volume of ad impressions for use in guaranteeing delivery of ad impressions, consider now an example device that can be used to implement one or more embodiments.

Example Device

FIG. 6 illustrates an example computing device 600 that can be used to implement the various embodiments described above. Computing device 600 can be, for example, advertising server 104 of FIG. 1, or any other suitable computing device.

Device 600 includes input device 602 that may include Internet Protocol (IP) input devices as well as other input devices, such as a keyboard. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface can enable device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.). A disk storage device may be implemented as any type of magnetic or optical storage device, such as a hard disk drive, a recordable and/or rewriteable compact disc (CD), any type of a digital versatile disc (DVD), and the like.

Computer-readable media 608 provides data storage to store content and data 610, as well as device executable modules and any other types of information and/or data related to operational aspects of device 600. One such configuration of a computer-readable medium is signal bearing medium and thus is configured to transmit the instructions (e.g., as a carrier wave) to the hardware of the computing device, such as via the network 106. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 612 can be maintained as a computer executable module with the computer-readable media 608 and executed on at least one or more processors 606. Device executable modules can also include an advertisement platform 614 which can include a forecasting module 616 and a bidding module 618 that, under the influence of at least one or more processors 606, operate as described above and below. Advertisement platform 614 can be, for example, advertisement platform 114 or advertisement platform 200.

Device 600 also includes an audio and/or video input/output 620 that provides audio and/or video data to an audio rendering and/or display system 622. The audio rendering and/or display system 622 can be implemented as integrated component(s) of the example device 600, and can include any components that process, display, and/or otherwise render audio, video, and image data.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
identifying an ad impression opportunity to be obtained from a non-guaranteed source of ad impressions;
receiving information regarding a sale of the ad impression opportunity by the non-guaranteed source of ad impressions; and
forecasting, based on received information regarding the sale of the ad impression opportunity, a forecasted available volume of ad impressions.

2. The computer-implemented method of claim 1, the non-guaranteed source of ad impressions comprising at least one real-time bidded platform.

3. The computer-implemented method of claim 1, receiving information regarding the sale of the ad impression opportunity comprising receiving: information that a bid transmitted is a winning bid, information that there has been a higher bid than a bid transmitted, information that an auction for the ad impression opportunity was won or lost, information regarding a winning bid amount, or information regarding an amount of a clearing price for the ad impression opportunity.

4. The computer-implemented method of claim 1, further comprising:
receiving an order for at least one ad impression; and
guaranteeing, based on the forecasted available volume of ad impressions, delivery of the at least one ad impression ordered.

5. The computer-implemented method of claim 4, further comprising:
responsive to guaranteeing delivery of the at least one ad impression ordered, updating the forecasted available volume of ad impressions.

6. The computer-implemented method of claim 4, further comprising:
obtaining, from the non-guaranteed source of ad impressions, at least one ad impression to fulfill the order.

7. The computer-implemented method of claim 6, obtaining at least one ad impression to fulfill the order comprising transmitting a winning bid to the non-guaranteed source of ad impressions.

8. The computer-implemented method of claim 1, further comprising:
receiving an order for at least one ad impression; and
proposing, based on the forecasted available volume of ad impressions, an alternative order for at least one ad impression.

9. The computer-implemented method of claim 8, proposing an alternative order comprising proposing an order for at least one ad impression at an alternative price, the alternative price being higher than a price in the received order.

10. One or more computer-readable storage media comprising instructions that are executable to cause a device to perform a process comprising:
receiving an order for a number of ad impressions at a price;
comparing the number of ad impressions in the order to a forecasted available volume of ad impressions at the price, the forecasted available volume of ad impressions being determined based on historical bid landscape data; and
responsive to the number of ad impressions in the order being less than or equal to the forecasted available volume of ad impressions at the price, guaranteeing a delivery of the number of ad impressions.

11. The one or more computer-readable storage media of claim 10, the process further comprising:
receiving a non-guaranteed ad impression opportunity;
transmitting, to a source of the non-guaranteed ad impression opportunity, a bid to purchase the non-guaranteed ad impression opportunity; and
receiving information regarding a sale of the non-guaranteed ad impression opportunity.

12. The one or more computer-readable storage media of claim 11, receiving information regarding the sale of the non-guaranteed ad impression opportunity comprising receiving: information that the transmitted bid is a winning bid, information that there has been a higher bid than the transmitted bid, information that an auction for the non-guaranteed ad impression opportunity was won or lost, information regarding a time of the sale of the non-guaranteed ad impression opportunity, information regarding a winning bid amount, or information regarding an amount of a clearing price for the ad impression opportunity.

13. The one or more computer-readable storage media of claim 11, the process further comprising:
including the received information regarding the sale of the non-guaranteed ad impression opportunity in the historical bid landscape data; and
calculating an updated forecasted available volume of ad impressions.

14. The one or more computer-readable storage media of claim 10, the process further comprising:
obtaining, from a non-guaranteed source of ad impressions, ad impressions to fulfill the order.

15. The one or more computer-readable storage media of claim 14, obtaining ad impressions comprising transmitting a winning bid to purchase the ad impressions available in an auction.

16. The one or more computer-readable storage media of claim 14, the source of the non-guaranteed ad impressions being a real-time bidded platform.

17. A device comprising:
one or more processors;
one or more computer-readable storage media; and
one or more modules embodied on the one or more computer-readable storage media and executable under the influence of the one or more processors, the one or more modules configured to:
identify an ad impression opportunity to be obtained from a non-guaranteed source of ad impressions;
receive information regarding a sale of the ad impression opportunity by the non-guaranteed source of ad impressions;
forecast, based on received information regarding the sale of the ad impression opportunity, a forecasted available volume of ad impressions;
receive an order for a number of ad impressions at a price;
compare the number of ad impressions in the order to the forecasted available volume of ad impressions at the price; and
responsive to the number of ad impressions in the order being less than or equal to the forecasted available volume of ad impressions at the price, guarantee a delivery of the number of ad impressions.

18. The device of claim 17, the one or more modules further configured to:
transmit a bid to purchase a subsequent ad impression opportunity from the non-guaranteed source of ad impressions;
receive information regarding a sale of the subsequent ad impression opportunity; and
update the forecasted available volume of ad impressions using the received information regarding the sale of the subsequent ad impression opportunity.

19. The device of claim 18, wherein the received information regarding the sale of the subsequent ad impression opportunity comprises information that the transmitted bid is a winning bid, information that there has been a higher bid than the transmitted bid, information that an auction for the subsequent ad impression opportunity was won or lost, information regarding a time of the sale of the subsequent ad impression opportunity, information regarding a winning bid amount, or information regarding an amount of a clearing price for the ad impression opportunity.

20. The device of claim 18, wherein the information regarding the sale of the subsequent ad impression opportunity comprises information that the bid to purchase the subsequent ad impression opportunity is a winning bid.
